(19) United States
(12) Patent Application Publication
(10) Pub. No.: US 2017/0001135 A1
(43) Pub. Date: Jan. 5, 2017

(54) Cabin Air Filter Device

(71) Applicant: Ron Paramore, Huntington Beach, CA (US)

(72) Inventor: Ron Paramore, Huntington Beach, CA (US)

(21) Appl. No.: 15/197,657

(22) Filed: Jun. 29, 2016

Related U.S. Application Data
(60) Provisional application No. 62/187,553, filed on Jul. 1, 2015.

(51) Int. Cl. B01D 46/00; B01D 39/20; B01D 39/16; B01D 46/52

(52) U.S. Cl. CPC B01D 46/0057; B01D 46/521; B01D 39/2068; B01D 39/1692; B01D 39/1615; B01D 2279/40

(57) ABSTRACT

A cabin air filter device for cleaning air entering a vehicle is provided. The cabin air filter device comprises a cabin air filter constructed from a washable and reusable material with the cabin air filter having an original shape. The cabin air filter is capable of being positioned within the a/c and heating system of the vehicle and is capable of being washed while substantially maintaining the original shape.

### CLAIM OF PRIORITY

This patent application claims priority under 35 USC 119 (e) (1) from U.S. Provisional Patent Application Ser. No. 62/187,553 filed Jul. 1, 2015, of common inventorship herewith entitled, “Smart Parts Reusable Cabin Air Filter,” which is incorporated herein by reference as though the same were set forth in its entirety.

### FIELD OF THE INVENTION

The present invention pertains to the field of clean air accessories, and more specifically to the field of air filters for rooms or vehicles.

### BACKGROUND OF THE INVENTION

Inventions are always a product of vision and creativity whether they are world changing inventions like cars and computers or everyday conveniences like pump hairsprays, cordless tools and resealable soda bottles. New inventions like a cell phone change a person's life style, making communication more convenient and accessible virtually anywhere. Other inventions such as a snow scraper and brush combine two already existing inventions into an improved embodiment, reducing clutter in our lives and making a daily winter chores much easier. Often necessity combined with a little creativity is the underlying motivator for an invention. Most inventions fill a relatively small need or perform a specialized limited function. If that need is shared by a sufficient number of consumers, an invention has a great potential for success.

A car, van, pickup or SUV is a serious investment on the part of vehicle owners and many owners want to keep their vehicles in optimal working order within reason financially. One maintenance task involves installing a new cabin air filter as needed.

The prior art has put forth several designs for air filters. Among these are:

U.S. Pat. No. 7,883,572 to Eckhard Neudeck describes a cleanable filter for particulate material that includes a zigzag pleated filter pack. Spacers are disposed between the pleats in the filter pack and a frame having an upper and lower part covering the respective upper and lower side of the filter pack. The filter pack contains the ends of the fold lines and two lateral parts covering the opposite sides of the filter pack that contains the ends of the filter medium zigzag folded into a filter pack. The frame thereby leaves the opposite sides of the filter pack free for the passage of air. The filter medium in the filter pack includes a pleated sheet of polytetrafluorethylene and the spacers between the pleats consist of corrugated aluminum foils. A grounding element electrically connects the aluminum foils to each other and to a ground connection on the outside of the filter frame.

U.S. Pat. No. 5,928,414 to Raymond M. Wnenchak, John E. Bacino, Stephen K. Stark and Erik H. Wildt describes a filter element constructed from expanded polytetrafluoroethylene or ePTFE membrane possessing high strength which is sufficient to withstand filtration processing, as well as permitting the use of low energy to flex and clean the filter element. The filter element eliminates adherence of lint and contamination due to the ePTFE membrane structure of the filter, thereby providing excellent filtration performance for a variety of industries requiring high efficiency filtration.

U.S. Pat. No. 5,095,882 to Steven S. Christensen describes an apparatus for a motor vehicle cooling system, comprising an after cooler for cooling turbocharged air entering an engine of the motor vehicle. A radiator is provided for cooling fluid circulating in the engine. The radiator is aligned substantially in series with the after cooler. A spacer is connected between the after cooler and the radiator. Trap doors are provided in the spacer for accessing the after cooler and radiator.

None of these prior art references describe the present invention.

### SUMMARY OF THE INVENTION

It is an object of the present invention to provide a high efficiency air filter configured to filter the air circulated in a motor vehicle's passenger cabin.

The present invention is a cabin air filter device for cleaning air entering a vehicle through an outside air intake. The cabin air filter device comprises a cabin air filter constructed from a washable and reusable material with the cabin air filter having an original shape. The cabin air filter is capable of being positioned within the air conditioning (a/c) and heating system of the interior of the vehicle and is capable of being washed while substantially maintaining the original shape.

In addition, the present invention includes a method for cleaning air entering the interior of a vehicle. The method comprises providing a cabin air filter having an original shape, constructing the cabin air filter from a washable and reusable material, positioning the cabin air filter within the a/c and heating system of the vehicle, removing the cabin air filter from the a/c and heating system of the vehicle, washing the cabin air filter, and maintaining the original shape of the cabin air filter.

The present invention further includes a cabin air filter device for cleaning air entering the interior of a vehicle through the a/c and heating system. The cabin air filter device comprises a pleated, high efficiency cabin air filter constructed from a washable and reusable material with the cabin air filter having an original shape. The cabin air filter is capable of being positioned within the a/c and heating system of the vehicle and is capable of being washed while substantially maintaining the original shape.

### BRIEF DESCRIPTION OF THE DRAWINGS

FIG. 1 is a perspective view illustrating a cabin air filter device, in accordance with the present invention, showing a pleated cabin air filter.

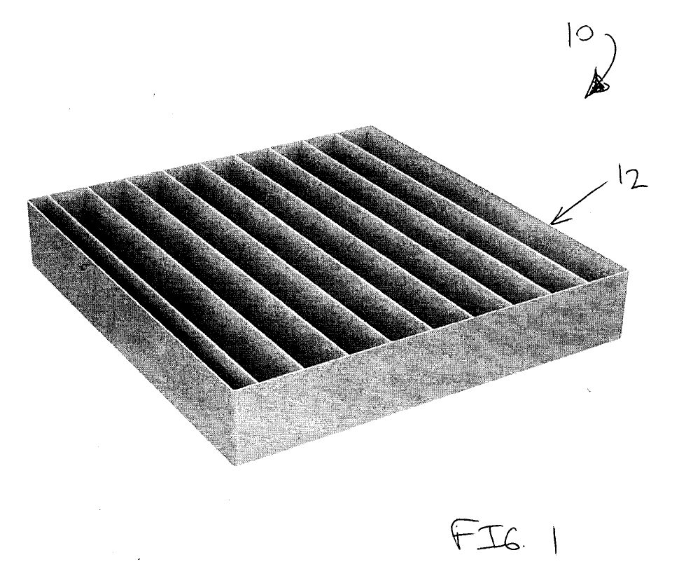

### DETAILED DESCRIPTION OF THE INVENTION

The present invention, hereinafter referred to as the Cabin Air Filter Device, indicated generally at 10, is an improved high efficiency cabin air filter 12 configured to filter the air circulated in a motor vehicle's passenger cabin. Unlike other cabin air filters, the cabin air filter 12 of the Cabin Air Filter Device 10 is washable and reusable.

The cabin air filter of the Cabin Air Filter Device 10 of the present invention is a cabin air filter 12 positioned in the a/c and heating system of the vehicle's passenger compartment. In a preferred embodiment, the cabin air filter 12 is pleated thereby increasing the cabin air filter area for filtering a greater amount of particles, dust, and debris. The number and size of the pleats of the cabin air filter 12 can vary depending on the needs and desires of the manufacturer and user.

The cabin air filter 12 of the Cabin Air Filter Device 10 of the present invention is of any suitable shape to accommodate any vehicle, but in many cases is preferably rectangular in shape to fit most outside air intakes of most vehicles. It should be noted, however, that it is within the scope of the present invention to construct the cabin air filter 12 in another shape or different shapes to fit the available space in the outside air intakes of the vehicle.

A unique difference between a current conventional disposable cabin air filter and the cabin air filter 12 of the Cabin Air Filter Device 10 of the present invention is the material which comprises the cabin air filter 12 of the present invention. The cabin air filter 12 of the Cabin Air Filter Device 10 is preferably constructed from a washable and rinsable plastic material, oiled cotton material, nylon, or similar material. Once the cabin air filter 12 is clogged or it is time for a regular change, for instance when the vehicle oil is changed, the cabin air filter 12 of the present invention is removed and rinsed of particles, dust, and debris. Once dried, the cabin air filter 12 of the Cabin Air Filter Device 10 is reinstalled and reused until it is time once again to wash, rinse, dry, and reinstall.

Being a relatively recent addition to automobile equipment, the cabin air filter 12 of the Cabin Air Filter Device 10 of the present invention is often overlooked, and can greatly reduce the effectiveness of a vehicle's air conditioning and heating performance. Clogged or dirty cabin air filters significantly reduce airflow from the cabin vents as well as introduce allergens such as pollen and dust into the cabin air stream. Generally speaking, cabin air filters cost between approximately ten dollars and forty dollars. Automakers recommend replacing the filter every twelve months or seventy five hundred miles which is a maintenance expense that adds up over time.

When using the cabin air filter 12 of the Cabin Air Filter Device 10 of the present invention, one cabin air filter lasts for years which greatly reduces vehicle maintenance costs. Additionally, unnecessary waste is avoided by using the present invention. The cabin air filter 12 of the Cabin Air Filter Device 10 also provides higher rates of effective filtration than current cabin air filters. In terms of a cabin air filter's performance and the respiratory health of a motorist and their passengers, the cabin air filter 12 and the Cabin Air Filter Device 10 is highly effective. Durably constructed of a high quality materials, the present invention will withstand many years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A cabin air filter device for cleaning air entering a vehicle, the cabin air filter device comprising:
a cabin air filter constructed from a washable and reusable material, the cabin air filter having an original shape;
wherein the cabin air filter is capable of being positioned within the a/c and heating system of the vehicle; and
wherein the cabin air filter is capable of being washed and substantially maintaining the original shape.

2. The cabin air filter device of claim 1 wherein the cabin air filter is a high efficiency air filter.

3. The cabin air filter device of claim 1 wherein the cabin air filter is pleated.

4. The cabin air filter device of claim 1 wherein the cabin air filter has a substantially rectangular shape.

5. The cabin air filter device of claim 1 wherein the cabin air filter is constructed from a plastic or nylon material.

6. The cabin air filter device of claim 1 wherein the cabin air filter is constructed from an oiled cotton material.

7. The cabin air filter device of claim 1 wherein the cab in air filter, once washed and dried, is capable of being positioned into the a/c and heating system of the vehicle.

8. A method for cleaning air entering a vehicle, the method comprising:
providing a cabin air filter having an original shape;
constructing the cabin air filter from a washable and reusable material;
positioning the cabin air filter within the a/c and heating system of the vehicle;
removing the cabin air filter from the a/c and heating system of the vehicle;
washing the cabin air filter; and
maintaining the original shape of the cabin air filter.

9. The method of claim 8 wherein the cabin air filter is a high efficiency cabin air filter.

10. The method of claim 8 and further comprising:
pleating the cabin air filter.

11. The method of claim 8 wherein the cabin air filter has a substantially rectangular shape.

12. The method of claim 8 and further comprising:
constructing the cabin air filter from a plastic or nylon material.

13. The method of claim 8 and further comprising:
constructing the cabin air filter from an oiled cotton material.

14. The method of claim 8 and further comprising:
positioning the cabin air filter into the a/c and heating system of the vehicle once the cabin air filter has been washed and dried.

15. A cabin air filter device for cleaning air entering a vehicle, the cabin air filter device comprising:
a pleated, high efficiency air filter constructed from a washable and reusable material, the cabin air filter having an original shape;
wherein the cabin air filter is capable of being positioned within the a/c and heating system of the vehicle; and
wherein the cabin air filter is capable of being washed and substantially maintaining the original shape.

16. The cabin air filter device of claim 15 wherein the cabin air filter is a high efficiency air filter.

17. The cabin air filter device of claim 15 wherein the cabin air filter has a substantially rectangular shape.

18. The cabin air filter device of claim 15 wherein the cabin air filter is constructed from a plastic material.

19. The cabin air filter device of claim 15 wherein the cabin air filter is constructed from an oiled cotton material.

20. The cabin air filter device of claim 15 wherein the cabin air filter, once washed and dried, is capable of being positioned into the a/c and heating system of the vehicle.
